(19) United States
(12) Patent Application Publication
(10) Pub. No.: US 2011/0000632 A1
(43) Pub. Date: Jan. 6, 2011

(54) Process to Make a Clay Comprising Charge-Balancing Organic Ions, Clays Thus Obtained, and Nanocomposite Materials Comprising the Same

(76) Inventors: Auke Gerardus Talma, Bathmen (NL); Aaldert Johannes De Jong, Voorthuizen (NL); Simon Bruijn, Deventer (NL); Jozef Johannes Maria Baltussen, Nijmegen (NL); Cornelis Elizabeth Johannus Van Lare, Wijchen (NL); Marianne Frederika Reedijk, Ochten (NL)

Correspondence Address: KENYON & KENYON LLP, ONE BROADWAY, NEW YORK, NY, 10004, US

(21) Appl. No.: 12/809,012

(22) PCT Filed: Dec. 16, 2008
(86) PCT No.: PCT/EP08/67657

§ 371 Date: Aug. 13, 2010

Related U.S. Application Data
(60) Provisional application No. 61/019,858, filed on Jan. 9, 2008.

(30) Foreign Application Priority Data
Dec. 21, 2007 (EP) 07123964.4

(51) Int. Cl. D21C 9/00; C09D 7/12; C08K 5/09

(52) U.S. Cl. 162/76; 106/287.24; 524/301

(57) ABSTRACT

The invention relates to a layered double hydroxide comprising a charge-balancing organic anion, wherein the charge-balancing anion is a monovalent anion comprising at least one hydroxyl group, and which comprises less than 20 wt % boehmite. Claimed are also an aqueous slurry, a water borne coating, a composite material and a master batch comprising the said layered double hydroxide as well as the use of the said layered double hydroxide in paper making processes and as stain blocking agent in water borne coating applications.

The invention relates to layered double hydroxides comprising a charge-balancing organic anion and their use. The invention further relates to nanocomposite materials comprising these layered double hydroxides and their use.

Such layered double hydroxides (LDHs) are known in the art. Various references such as WO 00/09599, WO 99/35185, and Carlino (Solid State Ionics, 98 (1997), pp. 73-84), disclose LDHs comprising hydrophobic organic anions, which are compatible with hydrophobic matrices such as polyolefins.

LDHs comprising more hydrophilic organic anions, such as hydroxyl-containing or amine-containing mono- and polycarboxylic acids, are also known in the art. Such layered double hydroxides are disclosed e.g. in US 2006/20069, US 2003/114699, U.S. Pat. No. 5,578,286, and by Hibino et al. (pu J. Mater. Chem., 2005, 15, pp. 653-656). These references generally disclose the preparation of such LDHs, which further contain a large amount of compounds based on the divalent or trivalent metal ion such as for example unconverted raw materials such as brucite and/or boehmite. These contaminating compounds generally have a negative effect on the properties of the matrix or medium in which these LDH compositions are used, e.g. in composite materials. The presence of these compounds considerably decreases the number of suitable applications.

U.S. Pat. No. 5,728,366 discloses an improved process wherein first a double hydroxide intermediate is formed, which is subsequently contacted with a monovalent organic anion at low temperatures to form an intercalated LDH. The process is too complicated to be of commercial interest. Also the resulting product has a too high Mg-salt level of the acid that is used.

In US 2003/0114699 another process is proposed wherein first an intermediate is formed by reacting the organic anion and the trivalent metal source, and in a second step the intermediate in water is reacted with a divalent cation source at a temperature up to 95° C. The process is cumbersome since it requires two steps and the use of the organic anion in the liquid phase, and the resulting product has a too high divalent metal-salt level of the acid that is used.

The object of the present invention is to i) provide a simplified process to make a high-purity layered double hydroxide (LDH) derived from a trivalent metal source and a divalent metal source and comprising a charge-balancing organic anion, ii) to provide high-purity layered double hydroxides comprising a hydrophilic charge-balancing anion, and iii) the use of said layered double hydroxides comprising a hydrophilic charge-balancing anion in a wider range of applications, particularly their use in nanocomposites such as (water borne) coatings and, in another embodiment, particularly their use in the paper industry.

This object is achieved by providing an aqueous process to make a LDH derived from, inter alia, one or more trivalent metal sources and one or more divalent metal sources and comprising one or more charge-balancing organic anions with at least one hydroxyl group, wherein an intercalated LDH is produced in one step at a high temperature. The resulting product is of the desired purity, meaning it comprises less than 20 wt % boehmite and less than 5% of the divalent metal salt of said organic anion with at least one hydroxyl group.

In one embodiment of the invention, the one-step reaction is conducted at a temperature above 110, preferably above 120, more preferably above 130, even more preferably above 140, more preferably still above 150, even more preferably still above 160, and most preferably above 170° C. The upper limit of the temperature is typically determined by energy costs and equipment ratings, since preferably boiling of the aqueous mixture is prevented by applying pressure. Pressures can range from atmospheric up to 300 bar. Suitably the upper temperature is below 300, preferably below 250, and most preferably below 200° C. A further upper temperature limit can be dictated by the decomposition temperature of the organic anion with at least one hydroxyl group. Particularly if this anion is a hydroxy-carboxylic acid, the temperature should be below the decarboxylation and/or dehydration temperature.

The layered double hydroxide according to the invention comprises one or more trivalent metal ions, one or more divalent metal ions, and one or more charge-balancing organic anions, wherein at least one charge-balancing anion is a monovalent organic anion comprising at least one hydroxyl group, and which comprises less than 20 wt % boehmite and less than 5 wt % of the salt of said divalent metal and said monovalent organic anion.

In general, the layered double hydroxide comprises an amount of carbonate anions as charge-balancing anions of below 20 percent by weight (wt %); preferably, the amount of carbonate anions is below 1 wt % and most preferably carbonate as charge-balancing anion is about absent. The low amount of charge-balancing carbonate anions in the LDH of the invention allows the LDH to be delaminated and/or exfoliated more easily in e.g. polymeric matrices and to be delaminated and/or exfoliated to a larger extent. These modified LDHs can be suitably used in a wider range of applications compared to similar LDHs having higher carbonate amounts. They can be used in polymeric matrices which are less hydrophobic and hydrophilic in nature such as for instance polylactic acid.

In general, the relatively low amount of boehmite and divalent metal salt of said organic anion with at least one hydroxyl group was found to render the LDHs of the invention suitable for a wider variety of applications. Besides, a large amount of boehmite is generally present when the conversion of boehmite as raw material into the LDH is insufficient. Preferably, the amount of boehmite is less than 10 wt %, based on the total weight of LDH and boehmite, more preferably it is less than 5 wt %, even more preferably less than 1 wt %, and most preferably boehmite is absent. Similarly, the amount of the divalent metal salt is less than 5 wt %, based on the total weight of LDH and boehmite, more preferably it is less than 3 wt %, even more preferably less than 1 wt %, and most preferably the divalent metal salt is about absent.

In one embodiment of the invention, the layered double hydroxide of the invention comprises a total amount of additional oxygen-containing materials—originating from the divalent and/or trivalent metal ion sources from which the layered double hydroxide is also made—of less than 30 wt %, based on the total weight of the LDH and the additional oxygen-containing material. Preferably, the amount of additional oxygen-containing material is less than 20 wt %, more preferably less than 15 wt %, even more preferably less than 10 wt %, and most preferably less than 5 wt %.

Examples of additional oxygen-containing materials include oxides and hydroxides of the divalent and/or trivalent metal ions such as boehmite, gibbsite, aluminium trihydroxide, magnesium oxide, and brucite.

In the context of the present application the term “charge-balancing organic anion” refers to organic ions that compensate for the electrostatic charge deficiencies of the crystalline clay sheets of the LDH. As the clay typically has a layered structure, the charge-balancing organic ions may be situated in the interlayer, on the edge or on the outer surface of the stacked clay layers. Such organic ions situated in the interlayer of stacked clay layers are referred to as intercalating ions.

Such a stacked clay or organoclay may also be delaminated or exfoliated, e.g. in a polymer matrix. Within the context of the present specification, the term “delamination” is defined as reduction of the mean stacking degree of the clay particles by at least partial de-layering of the clay structure, thereby yielding a material containing significantly more individual clay sheets per volume. The term “exfoliation” is defined as complete delamination, i.e. disappearance of periodicity in the direction perpendicular to the clay sheets, leading to a random dispersion of individual layers in a medium, thereby leaving no stacking order at all.

Swelling or expansion of the clays, also called intercalation of the clays, can be observed with X-ray diffraction (XRD), because the position of the basal reflections—i.e. the d(00/) reflections—is indicative of the distance between the layers, which distance increases upon intercalation. Reduction of the mean stacking degree can be observed as broadening, up to disappearance, of the XRD reflections or by an increasing asymmetry of the basal reflections (hk0).

Characterization of complete delamination, i.e. exfoliation, remains an analytical challenge, but may in general be concluded from the complete disappearance of non-(hk0) reflections from the original clay.

The ordering of the layers and, hence, the extent of delamination, can further be visualized with transmission electron microscopy (TEM).

The LDHs comprising charge-balancing organic anions have a layered structure corresponding to the general formula:

└Mₘ²⁺Mₙ³⁺(OH)₂ₘ₊₂ₙ┘X_{n/z}^{z-}·bH₂O (I)

wherein M²⁺ is a divalent metal ion such as Zn²⁺, Mn²⁺, Ni²⁺, Co²⁺, Fe²⁺, Cu²⁺, Sn²⁺, Ba²⁺, Ca²⁺, Mg²⁺, or a mixture thereof, M³⁺ is a trivalent metal ion such as Al³⁺, Cr³⁺, Fe³⁺, Co³⁺, Mn³⁺, Ni³⁺, Ce³⁺, and Ga³⁺, or a mixture thereof, m and n have a value such that m/n=1 to 10, and b has a value in the range of from 0 to 10. X is a monovalent anion comprising at least one hydroxyl group and optionally any other organic anion or inorganic anion including hydroxide, carbonate, bicarbonate, nitrate, chloride, bromide, sulfonate, sulfate, bisulfate, vanadates, tungstates, borates, and phosphates, where preferably less than 20% of the total amount of charge-balancing anions is carbonate.

For the purpose of this specification, carbonate and bicarbonate anions are defined as being of an inorganic nature.

The LDHs of the invention include hydrotalcite and hydrotalcite-like anionic LDHs. Examples of such LDHs are meixnerite, manasseite, pyroaurite, sjogrenite, stichtite, barberonite, takovite, reevesite, and desautelsite.

In one embodiment of the invention, the layered double hydroxide has a layered structure corresponding to the general formula:

└Mgₘ²⁺Alₙ³⁺(OH)₂ₘ₊₂ₙ┘X_{n/z}^{z-}·bH₂O (II)

wherein m and n have a value such that m/n=1 to 10, preferably 1 to 6, more preferably 2 to 4, and most preferably a value close to 3; b has a value in the range of from 0 to 10, generally a value of 2 to 6, and often a value of about 4. X is a charge-balancing ion as defined above. It is preferred that m/n should have a value of 2 to 4, more particularly a value close to 3.

The LDH may have any crystal form known in the art, such as described by Cavani et al. (Catalysis Today, 11 (1991), pp. 173-301) or by Bookin et al. (Clays and Clay Minerals, (1993), Vol. 41(5), pp. 558-564), such as 3H₁, 3H₂, 3R₁, or 3R₂ stacking.

The distance between the individual clay layers in the LDH of the invention is generally larger than the distance between the layers of an LDH that contains only carbonate as charge-balancing anion. Preferably, the distance between the layers in an LDH according to the invention is at least 1.0 nm, more preferably at least 1.1 nm, and most preferably at least 1.2 nm. The distance between the individual layers can be determined using X-ray diffraction, as outlined before. The distance between the individual layers includes the thickness of one of the individual layers.

The LDH of the invention comprises a monovalent charge-balancing anion comprising at least one hydroxyl group. Preferably, the monovalent anion comprises at most 12 carbon atoms, preferably at most 10 carbons atoms, and most preferably at most 8 carbon atoms, and at least 2 carbon atoms, more preferably at least 3 carbon atoms. The monovalent charge-balancing anion may comprise one hydroxyl group, two hydroxyl groups or three or more hydroxyl groups. A monovalent anion comprising one or two hydroxyl groups is preferred. In one embodiment, the charge-balancing anion is a monovalent anion selected from the group consisting of carboxylate, sulfate, sulfonate, phosphate, and phosphonate. Preferably, the monovalent charge-balancing anion is a monocarboxylate.

Examples of monocarboxylates which are in accordance with the present invention include aliphatic monocarboxylates such as glycolate, lactate, 3-hydroxypropanoate, α-hydroxybutyrate, β-hydroxybutyrate, γ-hydroxybutyrate, 2-hydroxy-2-methyl butyrate, 2-hydroxy-3-methyl butyrate, 2-ethyl-2-hydroxybutyrate, 2-hydroxycaproate, 2-hydroxyisocaproate, 10-hydroxydecanoate, 10-hydroxydodecanoate, dimethylol propionate, gluconate, glucuronate, glucoheptanoate; and aromatic or phenyl-containing monocarboxylates such as 4-hydroxyphenylpyruvate, 3-fluoro-4-hydroxyphenylacetate, 3-chloro-4-hydroxyphenylacetate, homovanillate, 3-hydroxy-4-methoxymandel ate, DL-3,4-d ihydroxymandelate, 2,5-dihydroxyphenylacetate, 3,4-d ihydroxyphenylacetate, 3,4-dihydroxyhydrocinnamate, 4-hydroxy-3-nitrophenyl acetate, 2-hydroxycinnamate, salicylate, 4-hydroxybenzoate, 2,3-dihydroxybenzoate, 2,6-dihydroxybenzoate, 3-hydroxy anthranilate, 3-hydroxy-4-methyl benzoate, 4-methyl salicylate, 5-methylsalicylate, 5-chlorosalicylate, 4-chlorosalicylate, 5-iodosalicylate, 5-bromosalicylate, 4-hydroxy-3-methoxybenzoate, 3-hydroxy-4-methoxybenzoate, 3,4-dihydroxybenzoate, 2,5-dihydroxybenzoate, 2,4-dihydroxybenzoate, 3,5-dihydroxybenzoate, 2,3,4-trihydroxybenzoate, gallate, and syringate. Preferred monocarboxylates are selected from the group consisting of glycolate, lactate, dimethylol propionate, gluconate, and salicylate. Lactate and dimethylol propionate are even more preferred monocarboxylates.

It is noted that some of the above monocarboxylates may exist in both the D and the L-form. It is contemplated to use either of the enantiomers in the LDH of the invention, or to use mixtures of the enantiomers.

It is further envisaged to use two or more of the above monovalent charge-balancing anions, in particular the monocarboxylates, as charge-balancing anions.

It is further contemplated that the charge-balancing monovalent anion comprises, next to the hydroxyl group(s), one or more functional groups such as acrylate, methacrylate, chloride, amine, epoxy, thiol, vinyl, di- and polysulfides, carbamate, ammonium, sulfonium, phosphonium, phosphinic, isocyanate, mercapto, hydroxyphenyl, hydride, acetoxy, and anhydride. If such organically modified LDHs are used in polymeric matrices, these functional groups may interact or react with the polymer.

The process of the invention for making the LDH comprising the monovalent charge-balancing organic anion having at least one hydroxyl group is a process wherein in a single step the trivalent metal source, the divalent metal source, water, and the source for the organic anion are all mixed and heated to a reaction temperature of at least 110° C.

In order to speed up the reaction it is typically preferred that one or both of the metal sources are milled to a d90 particle size of less than 10, preferably less than 5 microns. Such milling and the high reaction temperature typically result in a product with very good purity, as is demonstrated by the fact that the salt of the divalent metal and the organic anion is kept to a minimum.

In one embodiment of the invention, the molar ratio between the trivalent metal ion and the monovalent anion, in particular the monocarboxylate, used in the process for preparing the modified LDH of the invention generally is at least 0.6, preferably at least 0.7, and most preferably at least 0.8, and generally at most 1.5, preferably at most 1.4, and most preferably at most 1.3.

The invention further pertains to an aqueous slurry comprising the layered double hydroxide in accordance with the present invention. The amount of modified LDH generally is at least 0.1 wt %, preferably at least 0.2 wt %, and most preferably at least 0.5 wt %, and at most 50 wt %, preferably at most 30 wt %, and most preferably at most 20 wt %, based on the total weight of the aqueous slurry. These aqueous slurries are generally storage stable, i.e. no or hardly any sedimentation of solids is observed. Moreover, these slurries, in particular in higher concentrations, may have a relatively high viscosity, be thixotropic, and exhibit shear-thinning behaviour. The suspending medium in the aqueous slurry may be water, or it may be a mixture of water and a water-miscible solvent. The miscibility of the solvent with water can be determined using ASTM D 1722-98. Examples of such solvents include alcohols such as methanol, ethanol, n-propanol, isopropanol, n-butanol, i-butanol, and tert-butanol; alkane polyols such as ethylene glycol, propylene glycol, and glycerol; ethers such as dimethyl ether, diethyl ether or dibutyl ether; diethers of alkane polyols such as dimethyl ethylene glycol, diethyl ethylene glycol, dimethyl propylene glycol, and diethyl propylene glycol; and alkoxylated alcohols according to the formula

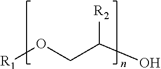

wherein R₁ is a C₁-C₈ alkyl or phenyl, R₂ is hydrogen or methyl, and n is an integer from 1 to 5; amines such as triethyl amine; non-ionic polymeric solvents such as polyethylene glycols, polypropylene glycols, lauryl polyethylene glycol; ionic liquids; pyridines; dimethyl sulfoxide; and pyrrolidones such as n-methylpyrrolidone. Also mixtures of two or more water-miscible solvents are envisaged. It is preferred that the suspending medium comprising both water and a water-miscible solvent does not segregate and form two layers.

It is also envisaged to use a suspending medium in which water is absent.

The LDH or the aqueous slurry of the invention can be used as a constituent in coating compositions, (printing) ink formulations, adhesive tackifiers, resin-based compositions, rubber compositions, cleaning formulations, drilling fluids and cements, plaster formulations, non-woven fabrics, fibres, foams, membranes, orthoplastic casts, asphalt, (pre-)ceramic materials, and hybrid organic-inorganic composite materials such as polymer-based nanocomposites. The LDH of the invention can further be used in polymerization reactions such as solution polymerization, emulsion polymerization, and suspension polymerization. The organoclay may further serve as a crystallization aid in semi-crystalline polymers. The LDH of the invention can further be used in applications where the separate functions of the LDH and the organic anions may be combined, such as in the paper making process or the detergent industry. Additionally, the LDH of the invention can be used in controlled release applications for medicines, pesticides, and/or fertilizers, and as sorbent of organic compounds such as pollutants, colourants, etc.

In a further embodiment of the invention, the modified LDH of the invention is used in the paper making process. In particular, the modified LDH can be used as anionic trash catcher (ATC), i.e. is capable of removing through adsorption anionic material such as rosin which is present in the paper pulp and which negatively interacts with or influences the performance of paper additives such as retention agents. The LDH of the invention generally has a higher capacity for the said anionic material than conventional materials such as talcum or layered double hydroxides containing inorganic charge-balancing anions, and can thus be used in considerably lower amounts. Further details can be gleaned from WO 2004/046464.

The invention further pertains to the use of the modified LDH of the invention as stain blocker in water borne coating applications. Water borne coatings have the problem that certain (water-soluble) products contained in the material onto which the coating is applied migrate through the coating and cause discolouration of the coating layer (this is also referred to as “bleeding”). Such bleeding phenomena can be found on tropical woods containing tannins for example, and on walls containing nicotine or tar stains.

The modified LDH can thus be suitably used in water borne wood coatings such as joinery and trim paints, and in water borne wall paints such as latexes. The advantage of the LDH of the invention is increased compatibility with a wider range of binders used in these water borne coatings, and increased stain-blocking performance compared to conventional stain-blocking systems. A further advantage is the suitability and ease of use of aqueous slurries of the modified LDH in these water borne coatings.

The amount of modified LDH generally used is at least 0.1 wt %, preferably at least 0.2 wt %, and most preferably at least 0.5 wt %, and at most 20 wt %, preferably at most 15 wt %, and most preferably at most 10 wt %, based on the total weight of the water borne coating.

The invention further pertains to composite materials, in particular nanocomposite materials, comprising a polymeric matrix and the modified LDH according to the invention. Using the modified LDHs of the invention a higher degree of exfoliation and/or delamination can be obtained in a wider variety of polymer matrices, and the amount of micrometer-sized modified LDHs will generally be lower or even absent. This enables the use of a lower amount of the modified LDH in nanocomposite materials. It may therefore be possible to provide nanocomposite materials with a relatively low density and good mechanical properties. Completely exfoliated and/or delaminated LDHs in the nanocomposite materials may render the material transparent to visible light, and thus make it suitable for use in optical applications.

The term “composite material” includes microcomposite materials and nano-composite materials. The term “nanocomposite material” refers to a composite material wherein at least one component comprises an inorganic phase with at least one dimension in the 0.1 to 100-nanometer range. The term “microcomposite material” refers to a composite material wherein at least one component comprises an inorganic phase which is larger than 100 nanometers in all of its dimensions.

The polymer that can be suitably used in the (nano)composite material of the invention can be any polymer matrix known in the art. In this specification, the term “polymer” refers to an organic substance of at least two building blocks (i.e. monomers), thus including oligomers, copolymers, and polymeric resins. Suitable polymers for use in the polymer matrix are both poly-adducts and polycondensates. The polymers may further be homopolymers or copolymers.

Preferably, the polymeric matrix has a degree of polymerization of at least 20, more preferably of at least 50. The term “degree of polymerization” has the conventional meaning and represents the average number of repeating units.

Examples of suitable polymers are vinyl polymers, such as polystyrene, polymethyl methacrylate, polyvinyl chloride, polyvinylidene chloride or polyvinylidene fluoride, saturated polyesters, such as polyethylene terephthalate, polylactic acid, or poly(ε-caprolactone), unsaturated polyester resins, acrylate resins, methacrylate resins, polyimides, epoxy resins, phenol formaldehyde resins, urea formaldehyde resins, melamine formaldehyde resins, polyurethanes, polycarbonates, polyaryl ethers, polysulfones, polysulfides, polyamides, polyether imides, polyether ketones, polyether ester ketones, polysiloxanes, polyurethanes, polyepoxides, and blends of two or more polymers. Preferably used are vinyl polymers, polyesters, polycarbonates, polyamides, polyurethanes or polyepoxides.

The organoclay according to the invention is particularly suitable for use in thermoplastic polymers such as polystyrene and acetal (co)polymers such as polyoxymethylene (POM), and in rubbers (latices) such as natural rubber (NR), styrene-butadiene rubber (SBR), polyisoprene (IR), polybutadiene (BR), polyisobutylene (IIR), halogenated polyisobutylene, butadiene nitrile rubber (NBR), hydrogenated butadiene nitrile (HNBR), styrene-isoprene-styrene (SIS) and similar styrenic block copolymers, poly(epichlorohydrin) rubbers (CO, ECO, GPO), silicone rubbers (Q), chloroprene rubber (CR), ethylene propylene rubber (EPM), ethylene propylene diene rubber (EPDM), polysulfide rubber (T), fluorine rubbers (FKM), ethylene vinyl acetate rubber (EVA), polyacrylic rubbers (ACM), polyurethanes (AU/EU), and polyester/ether thermoplastic elastomers.

The amount of LDH in the composite material, in particular in the nano-composite material, preferably is 0.01-75 wt %, more preferably 0.05-50 wt %, even more preferably 0.1-30 wt %, based on the total weight of the mixture. LDH amounts of 10 wt % or less, preferably of 1-10 wt %, more preferably of 1-5 wt %, are especially advantageous for the preparation of polymer-based nanocomposites, i.e. polymer-containing compositions according to the invention that contain delaminated—up to exfoliated—organically modified LDH.

LDH amounts of 10-70 wt %, more preferably of 10-50 wt %, are especially advantageous for the preparation of so-called masterbatches, i.e. highly concentrated additive premixes for, e.g., polymer compounding. Although the clay in such masterbatches in general is not completely delaminated and/or exfoliated, further delamination and/or exfoliation may be reached at a later stage, if so desired, when blending the masterbatch with a further polymer to obtain true polymer-based nanocomposites.

The nanocomposite material of the present invention can be prepared according to any method known to a person skilled in the art. A skilled person may intimately mix a polymer matrix and the organoclay according to the invention by using melt-blending techniques, for instance. This method is preferred, as it is simple, cost-effective, and readily applicable in existing plants. It is also envisaged to prepare the clay of the invention in the presence of the polymer matrix, or in the presence of the monomers and/or oligomers before, while or after the monomers and/or oligomers are polymerized to form the polymer matrix.

The present invention is further illustrated in the Examples below.

### EXAMPLES

### Example 1

123.2 grams of magnesium oxide (Zolitho® 40, ex Martin Marietta Magnesia Specialties LLC) and 117.4 grams of aluminium trihydroxide (Alumill F505) were mixed in 1,900 grams of demineralized water and ground to an average particle size (d₅₀) of 2.7 μm. The slurry was fed to an oil-heated autoclave equipped with a high-speed stirrer. Then 168 grams of lactic acid (88% purity ex Baker) were added to the autoclave over a period of 15 minutes. After the acid addition, the autoclave was closed and heated to 170° C. and kept there for 4 hours. Subsequently the autoclave was cooled to below 70° C. within 1 hour and the resulting slurry was removed.

The resulting layered double hydroxide comprising lactate was analyzed with X-ray diffraction to determine the inter-gallery spacing or d-spacing. The XRD pattern of the layered double hydroxide as prepared above shows minor hydrotalcite-related non-(hk0) reflections, indicating intercalation of the anionic clay. The intercalate exhibits a characteristic d(00/) value of 14.6 Å. Boehmite was absent from the product and the amount of Mg-lactate was less than 5 wt %.

Comparative Example A, According to the Recipe Described in US patent 2003-0114699A1:

500 grams of demineralized water and 17.05 grams of Catapal B (Sasol, 91.49% purity) were dosed to a 3-litre SS oil-heated autoclave under sufficient stirring conditions to avoid segregation.

Next, 24.20 grams of lactic acid (Purac T, 88% purity) were dosed to the reactor.

Then the contents of the reactor were heated from ambient temperature to 80° C. and allowed to react for 8 hours. After this period 17.96 grams of magnesium oxide (Zolitho® 40, ex Martin Marietta Magnesia Specialties LLC, 98% purity) were dosed to the reaction mixture, followed by the addition of 1,500 grams of demineralized water. Finally, the reaction mixture was heated from 80° C. to 95° C. and this temperature was maintained for 8 hours. After cooling down to ambient temperature the contents of the reactor were collected and appeared to have a pH of 9.3, a solid content of 3.2 wt %, and to exhibit thixotropic properties. X-ray diffraction analysis performed on a dried sample revealed that about 25% boehmite was present, as well as traces of Mg-lactate anhydrate.

### Comparative Example B, Preparation at T<110C

55.14 grams of magnesium oxide (Zolitho® 40, ex Martin Marietta Magnesia Specialties LLC, 98% purity) and 52.45 grams of aluminium trihydroxide (Alumill F505) were mixed in 2,022.4 grams of demineralized water and ground to an average particle size (d₅₀) of 2.35 μm. The slurry was fed into a 3-litre SS oil-heated autoclave under sufficient stirring conditions to avoid segregation. Next, 83.96 grams of lactic acid (88% purity ex Baker) were added to the autoclave. After the acid addition, the autoclave was closed and heated to 95° C., followed by this temperature being maintained for 4 hours.

Finally, the autoclave was cooled down to below 50° C. within 1 hour and subsequently the contents of the reactor were collected.

The resulting layered double hydroxide comprising lactate was analyzed with X-ray diffraction to determine the inter-gallery spacing or d-spacing. The XRD pattern of the layered double hydroxide as prepared above, however, revealed that a mixture of Mg-lactate, ATH (gibbsite), and MDH (brucite) had formed at the applied reaction conditions. More than 5% of Mg-lactate was present.

1. A process to make a layered double hydroxide comprising a charge-balancing organic anion having at least one hydroxyl group, the process comprising the step of contacting, at a temperature of at least 110° C., a trivalent metal source, a divalent metal source, water, and said organic anion.

2. The process of claim 1 wherein the temperature is at least 150° C.

3. The process of claim 1 wherein the organic anion is the anion of a carboxylic acid having at least one hydroxyl group, and the temperature is kept below the decarboxylation temperature of said anion.

4. The process of claim 1 wherein one or more of the metal sources are milled prior to or during the contacting step.

5. A layered double hydroxide comprising one or more trivalent metal ions, one or more divalent metal ions and one or more charge-balancing organic anions, wherein at least one charge-balancing organic anion is a monovalent organic anion comprising at least one hydroxyl group, and wherein the layered double hydroxide comprises less than 20 wt % boehmite and less than 5 wt % of a salt of said divalent metal and said monovalent organic anion comprising at least one hydroxyl group.

6. The layered double hydroxide according to claim 5 wherein the one or more charge-balancing organic anions comprises less than 20 wt % of carbonate anions.

7. The layered double hydroxide according to claim 5 wherein the monovalent organic anion is a monocarboxylate.

8. The layered double hydroxide according to claim 7 wherein the monocarboxylate is selected from the group consisting of glycolate, lactate, 3-hydroxypropanoate, α-hydroxybutyrate, β-hydroxybutyrate, γ-hydroxybutyrate, 2-hydroxypentanoate, dimethylol propionate, gluconate, glucuronate, glucoheptanoate, and mixtures thereof.

9. An aqueous slurry comprising the layered double hydroxide according to claim 5.

10. A water borne coating comprising the layered double hydroxide according to claim 5.

11. A composite material comprising the layered double hydroxide according to claim 5 and a polymeric matrix.

12. The composite material according to claim 11 comprising 1-10 wt % of the layered double hydroxide, based on the total weight of the composite material.

13. A masterbatch comprising 10-70 wt % of the layered double hydroxide according to claim 5, based on the total weight of the masterbatch, and 30-90 wt % of a polymer.

14. (canceled)

15. (canceled)

16. A process for removing an anionic material from paper pulp, the process comprising:
removing the anionic material from the paper pulp via adsorption with the layered double hydroxide according to claim 5.

17. The process of claim 16 wherein the anionic material is rosin.

18. The process of claim 3 wherein the carboxylic acid is lactic acid.

19. The process of claim 3 wherein one or more of the metal sources are milled prior to or during the contacting step.

20. An aqueous slurry comprising the layered double hydroxide according to claim 8.

21. A water borne coating comprising the layered double hydroxide according to claim 8.

22. A masterbatch comprising 10-70 wt % of the layered double hydroxide according to claim 8, based on the total weight of the masterbatch, and 30-90 wt % of a polymer.
